(19) United States
(12) Patent Application Publication
(10) Pub. No.: US 2012/0254066 A1
(43) Pub. Date: Oct. 4, 2012

(54) METHODS AND APPARATUS FOR VALUING MORTGAGE LOAN PORTFOLIOS

(75) Inventors: Terrence Joseph Glomski, Chicago, IL (US); Dmitry Gasinsky, Chicago, IL (US); Robert A. Baxter, JR., Chicago, IL (US); Laura Marie Ladewski, Chicago, IL (US)

(73) Assignee: NEUBERGER BERMAN FIXED INCOME LLC, New York, NY (US)

(21) Appl. No.: 13/436,328

(22) Filed: Mar. 30, 2012

Related U.S. Application Data
(60) Provisional application No. 61/470,240, filed on Mar. 31, 2011.

(51) Int. Cl. G06Q 40/06

(52) U.S. Cl. 705/36 R

(57) ABSTRACT

The system and methods disclosed herein are directed to valuing, comparing, and projecting mortgage loan portfolios based on residential real estate. The disclosed system enables portfolio managers to efficiently and accurately evaluate mortgage loan portfolios based on residential real estate. In one embodiment, a user can run detailed scenarios and then review comprehensive results of scenario runs using interactive tabs. The user can modify scenarios, assumptions, and individual parameters on the fly. The system provides aggregated information about a selected portfolio, as well as loan level information, from the same application.

### TECHNICAL FIELD

The present application relates in general to valuing mortgage loan portfolios and specifically to valuing mortgage loan portfolios based on residential real estate.

### BACKGROUND

Certain mortgage loan portfolios consist of a group or pool of mortgage loans, such as commercial or residential real estate. These mortgage loan portfolios are financial assets that banking institutions can hold, buy, and sell as an investment. Because such portfolios are used as a part of investment strategy or as a part of financial transactions, it is important to be able to correctly identify, evaluate, compare, and project the value of the portfolios. Banking or other financial institutions, as well as investment advisory companies and investment management companies, often hold, buy, and sell mortgage loan portfolios. Further, mortgage loan portfolios are often held, bought, and sold in bulk or in pools. In some cases, these transactions also occur between multiple parties.

The nature of these investment strategies and transactions as well as the nature of the subject matter make it difficult to accurately assess the value of mortgage loan portfolios. Some prior art systems attempt to accurately value the price of homes. These systems may attempt to account for economic conditions of a metropolitan statistical area. However, systems that simply value the price of homes are not useful for users who need to hold, buy, and sell complex financial assets based on reliable evaluation, comparison, and projection of mortgage loan portfolios that may then be pooled together and bought and sold in bulk.

Some systems may attempt to value mortgage loan portfolios but do not provide an integrated application that combines financial models, evaluation tools, rules engines, and underlying historical data to enable a user to evaluate the value of mortgage loan portfolios in an integrated application.

What is needed is an improved system and method to enable portfolio managers to efficiently and accurately evaluate, compare, and project mortgage loan portfolios based on residential real estate.

### SUMMARY

The system and method disclosed herein enable users to accurately and easily analyze the value of mortgage loan portfolios based on real estate. The system integrates forecasting modeling tools with multi-loan analytics display tools into a single application with a rich environment for simulating various market conditions and reviewing simulation results.

In one embodiment, a user can analyze a portfolio of loans to determine the value of the loans under various market conditions. The user can run detailed scenarios and provide values for parameters that may influence the portfolio of loans. In one embodiment, the loans contain information about residential real estate.

The user can review the results of scenario runs using interactive tabs. The report tabs present comprehensive performance and risk analytics at the loan level and at the portfolio level based on each scenario specified by the user. For example, the interactive tabs may include results for projected monthly cash flows, projected rates of default and prepayment, projected principal losses, and intrinsic valuations.

The interactive tabs allow the user to view the results at a variety of levels. One results level provides results in an aggregated manner allowing the user to analyze entire portfolios of loans. Another results level provides results for each loan included in a portfolio, allowing the user to analyze individual loans. Another results level lets the user view results for different scenarios where the user can review the impact of specific variables. The user can drill down through various results levels to review the results at the desired level of granularity.

Additional features and advantages are described herein, and will be apparent from the following Detailed Description and the figures.

### BRIEF DESCRIPTION OF THE FIGURES

FIG. 1 is a high level block diagram of an example communications system.

FIG. 2 is a more detailed block diagram showing one example of a computing device.

FIG. 3 illustrates an example screenshot of a main application window.

FIG. 4A illustrates an example screenshot of projected macroeconomic scenario data.

FIG. 4B illustrates an example screenshot of projected macroeconomic scenario charts.

FIG. 5A illustrates an example screenshot for defining or editing a projection scenario.

FIG. 5B illustrates another example screenshot for defining or editing a projection scenario.

FIG. 5C illustrates another example screenshot for defining or editing a projection scenario.

FIG. 6 illustrates an example screenshot of different attributes and definitions that the user can specify in defining a scenario.

FIG. 7 illustrates an example screenshot for selecting a portfolio of loans and a holdings date for the scenario run.

FIG. 8 illustrates an example screenshot of a Summary tab.

FIG. 9 illustrates an example screenshot of a By Scenario tab.

FIG. 10 illustrates an example screenshot of a By Aggregation tab.

FIG. 11 illustrates an example screenshot of a By Analytics tab.

FIG. 12 illustrates an example screenshot of a Loans tab.

FIG. 13 illustrates an example screenshot of different field names that the user can view for each loan included in the scenario run.

### DETAILED DESCRIPTION

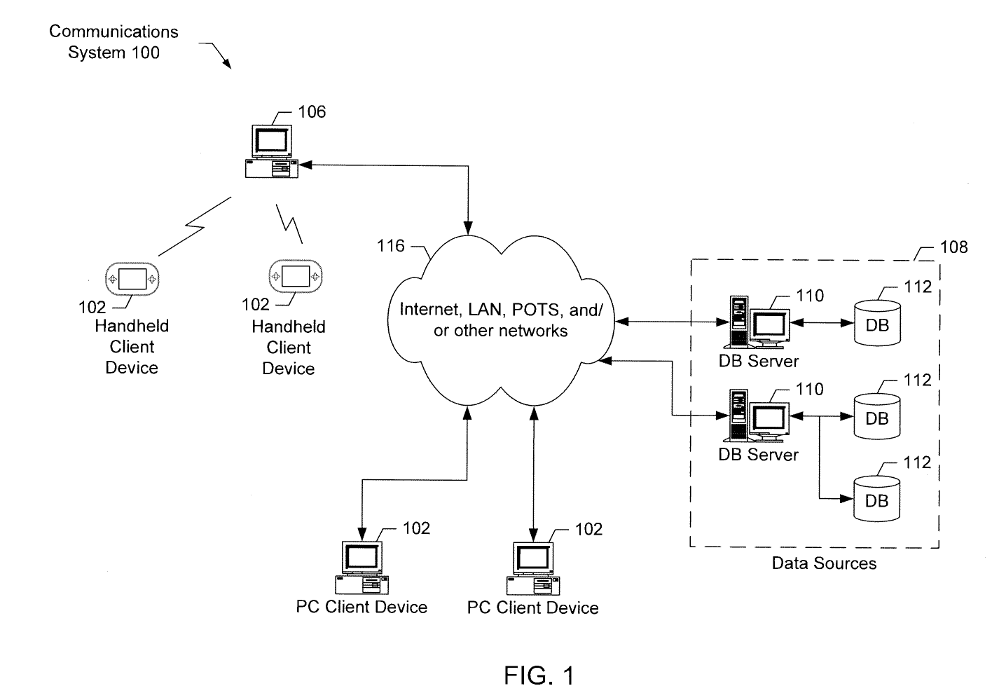

The present system is most readily realized in a network communications system. A high level block diagram of an exemplary network communications system 100 is illustrated in FIG. 1. The illustrated system 100 includes one or more client devices 102, one or more application servers 106 and one or more database servers 110 connected to one or more databases 112. Each of these devices may communicate with each other via a connection to one or more communications channels 116. The communications channels 116 may be any suitable communications channels 116 such as the Internet, cable, satellite, local area network, wide area networks, telephone networks, etc. It will be appreciated that any of the devices described herein may be directly connected to each other and/or connected over one or more networks.

One application server 106 may interact with a large number of client devices 102. Accordingly, each application server 106 is typically a high end computing device with a large storage capacity, one or more fast microprocessors and one or more high speed network connections. Conversely, relative to a typical application server 106, each client device 102 typically includes less storage capacity, less processing power and a slower network connection.

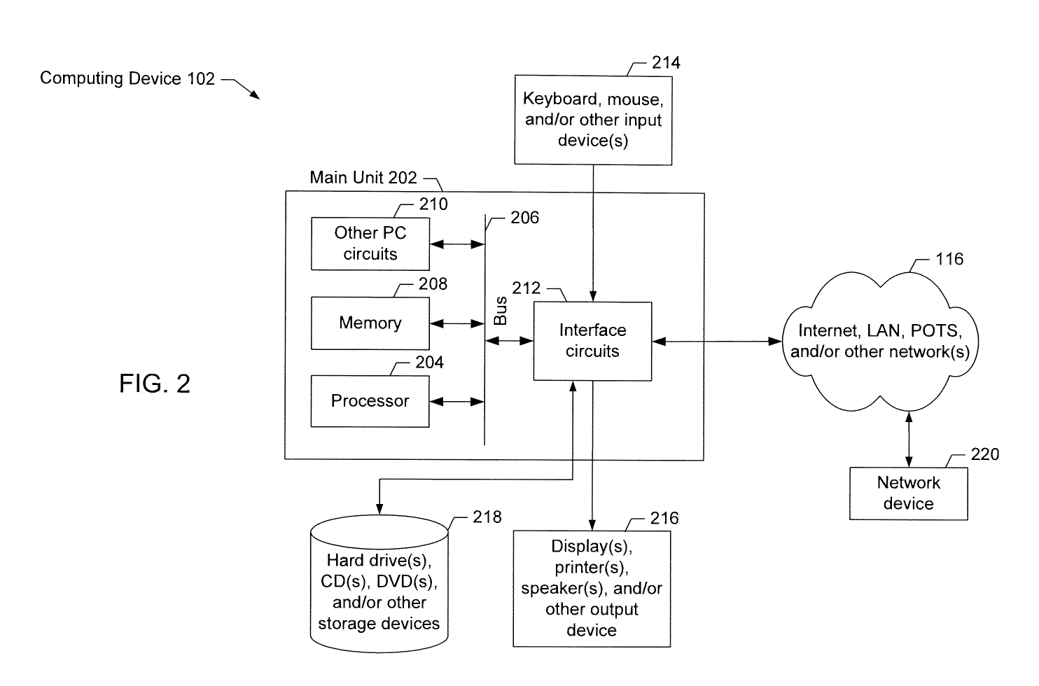

A detailed block diagram of an example computing device 102 is illustrated in FIG. 2. Each computing device 102 may include a server, a personal computer (PC), a personal digital assistant (PDA) and/or any other suitable computing device. Each computing device 102 preferably includes a main unit 202 which preferably includes one or more processors 204 electrically coupled by an address/data bus 206 to one or more memory devices 208, other computer circuitry 210 and one or more interface circuits 212. The processor 204 may be any suitable microprocessor.

The memory 208 preferably includes volatile memory and non-volatile memory. Preferably, the memory 208 and/or another storage device 218 stores software instructions that interact with the other devices in the system 100 as described herein. These software instructions may be executed by the processor 204 in any suitable manner. The memory 208 and/or another storage device 218 may also store one or more data structures, digital data indicative of documents, files, programs, web pages, etc. retrieved from another computing device 102 and/or loaded via an input device 214.

The example memory device 208 stores software instructions, web pages, user data and other information for use by the system as described in detail below. It will be appreciated that many other data fields and records may be stored in the memory device 208 to facilitate implementation of the methods and apparatus disclosed herein. In addition, it will be appreciated that any type of suitable data structure (e.g., a flat file data structure, a relational database, a tree data structure, etc.) may be used to facilitate implementation of the methods and apparatus disclosed herein.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint and/or a voice recognition system.

One or more displays, printers, speakers and/or other output devices 216 may also be connected to the main unit 202 via the interface circuit 212. The display 216 may be a cathode ray tube (CRT), liquid crystal display (LCD), or any other type of display. The display 216 generates visual displays of data generated during operation of the computing device 102. For example, the display 216 may be used to display web pages received from the application server 106. The visual displays may include prompts for human input, run time statistics, calculated values, data, etc.

One or more storage devices 218 may also be connected to the main unit 202 via the interface circuit 212. For example, a hard drive, CD drive, DVD drive, flash memory drive and/or other storage devices may be connected to the main unit 202. The storage devices 218 may store any type of data used by the computing device 102.

Each computing device 102 may also exchange data with other computing devices 102 and/or other network devices 220 via a connection to the communication channel(s) 116. The communication channel(s) 116 may be any type of network connection, such as an Ethernet connection, WiFi, WiMax, digital subscriber line (DSL), telephone line, coaxial cable, etc. Users 118 of the system 100 may be required to register with the application server 106. In such an instance, each user may choose a user identifier (e.g., e-mail address) and a password which may be required for the activation of services. The user identifier and password may be passed across the communication channel(s) 116 using encryption built into the user's browser, software application, or computing device 102. Alternatively, the user identifier and/or password may be assigned by the application server 106.

In one embodiment, the user may define and run multiple customized performance scenarios simultaneously across loan portfolios. The user can specify market conditions that may influence the value of mortgage loan portfolios.

In one embodiment, the mortgage loan portfolio valuation system allows the user to select from a list of pre-existing scenarios. In one embodiment, the mortgage loan portfolio valuation system allows the user to implement custom, client-specific requirements. For example, a user may want to specify accounting treatment modes, customized stress scenarios, or a customized output.

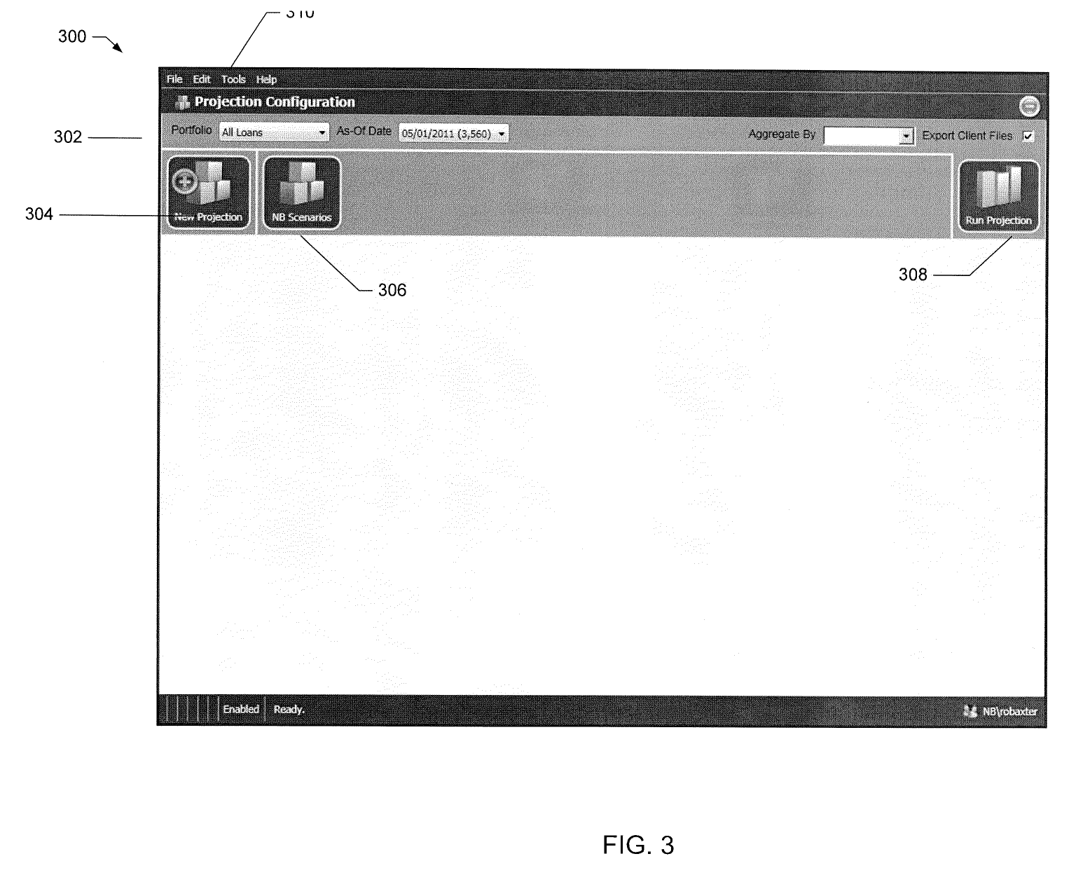

In one embodiment, the user launches an application on a computer. The user then specifies the portfolio of loans for analysis and selects scenarios or adds newly-defined scenarios. FIG. 3 illustrates an example screenshot 300 of a main window. In this example, the user can specify the portfolio of loans 302 that will be analyzed. The portfolio that is loaded may be filtered, for example, only fixed loans may be loaded. In one embodiment, a portfolio of aggregated loans may be loaded into the application. The user can choose to specify a new scenario or projection 304 or use a pre-existing scenario 306. The mortgage loan portfolio valuation system may provide only one pre-existing scenario or multiple pre-existing scenarios to the user. The user can then run a projection 308.

At any time, the user can view the underlying data upon which the scenarios will be run by using tools menu 310. In one embodiment, underlying data represent economic conditions, such as but not limited to employment rate, the interest rate, and housing prices. The underlying data in one embodiment represent variables or constants input by the user. For example, as the user is specifying a portfolio of loans and/or scenarios, he may be able to view and modify details of projections for home prices, unemployment rates or interest rates. In one embodiment, underlying data is periodically updated as economic conditions change.

It should be appreciated that modifying the underlying data allows running of scenarios under various different projections of economic conditions. The underlying data loaded into the mortgage loan portfolio valuation system may be based upon economic data available from various financial institutions.

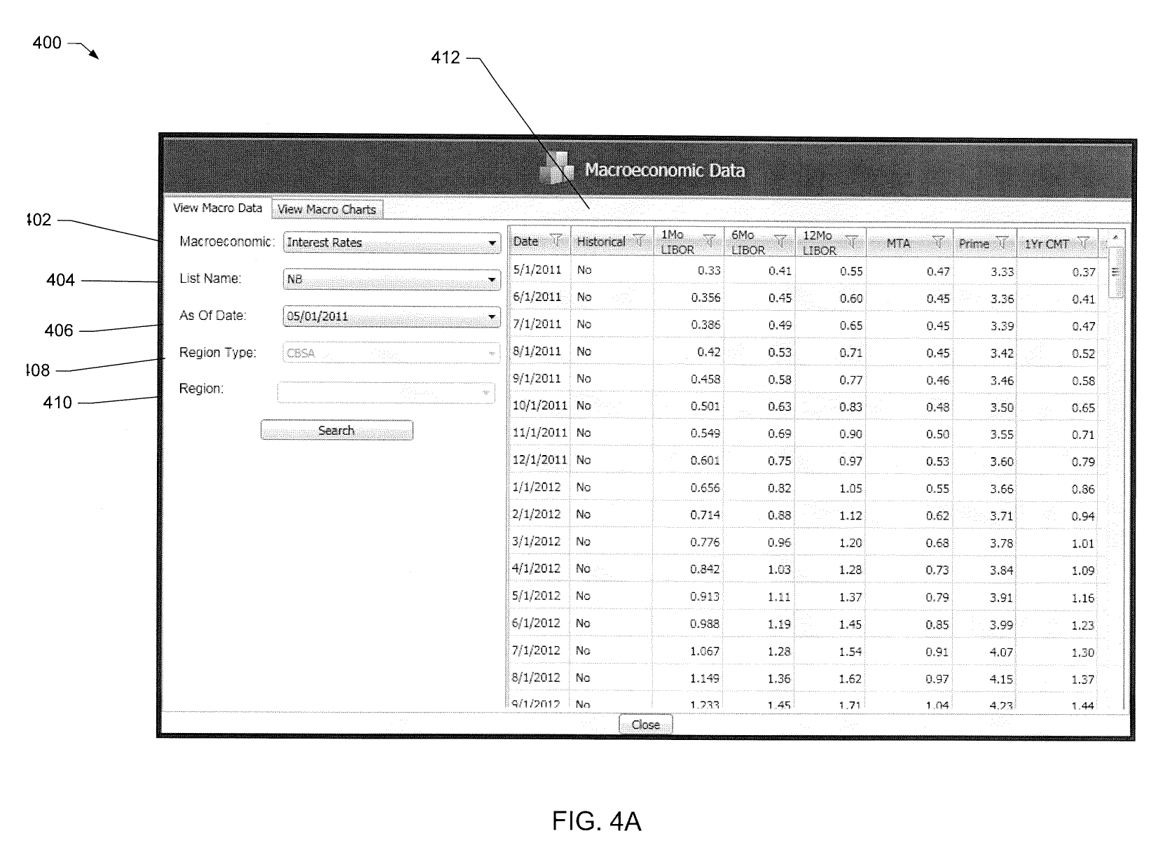

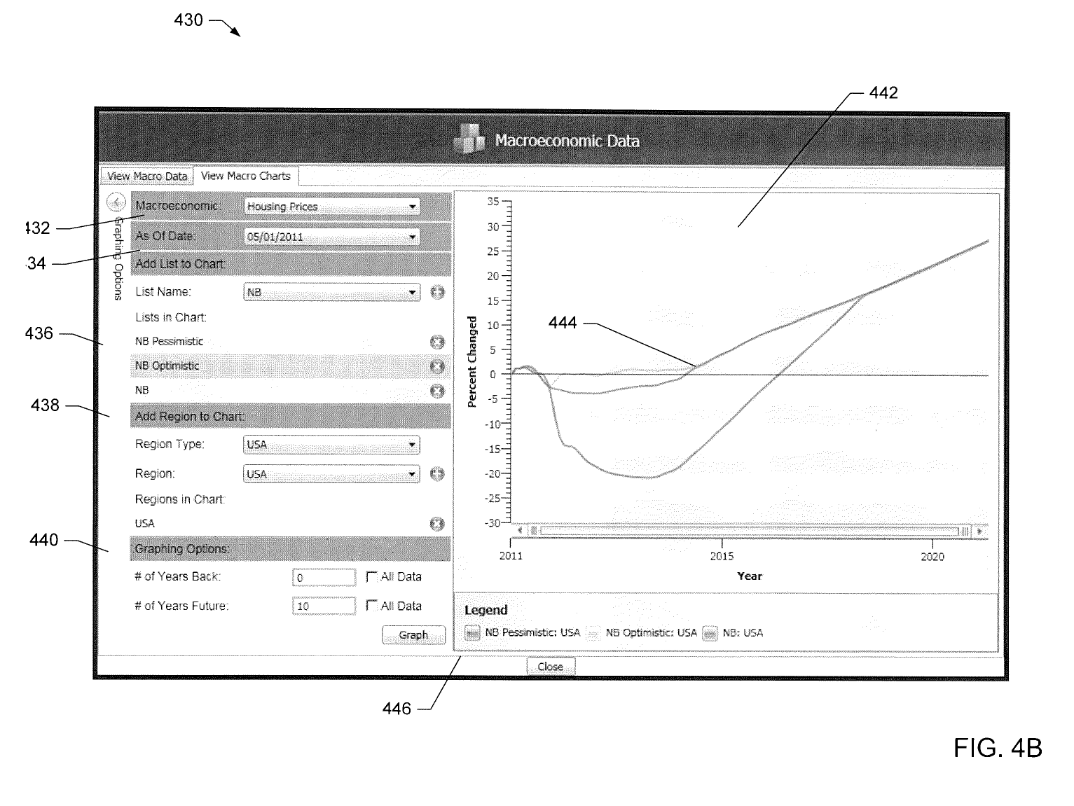

FIG. 4A illustrates an example screenshot 400 of projected macroeconomic data. Using this example interface, the user can view attributes for the underlying data such as macroeconomic conditions (such as interest rates) 402, list name 404, effective date 406, region type 408, and region 410. The user can view details 412 of the macroeconomic data upon with the scenarios are built. The user can modify any of the fields 402, 404, 406, 408 and 410 by selecting the respective drop-down box and choosing a new value for the field. For example, selecting the drop-down box associated with list name 404 allows the user to select from multiple lists that represent differing economic conditions. Details of macroeconomic data 412 may include historical data as well as future data representing macroeconomic information about the value selected under field 402, e.g., interest rates. In one embodiment, the user may modify field 402 to select a different macroeconomic condition, e.g., home prices.

FIG. 4B illustrates an example screenshot 430 of projected macroeconomic charts. The charts allow the user to graph a macroeconomic condition 432, e.g., housing prices. The user can specify the effective date 434 and add various lists 436 representing differing economic conditions. The user may also specify regions 438 and graphing options 440 for the chart. A macroeconomic chart 442 according to the user's selections is provided. In one embodiment, the chart 442 illustrates all the lists 436 selected by the user. It should be appreciated that the macroeconomic chart 442 allows the user to view, easily and at a high level, various macroeconomic data in the form of graphs 444 at the same time. The information in the lists can be view related to each other, providing context in a quick and efficient manner. The graphs may be colored for ease of use. A legend 446 may indicate the colors corresponding to each graph. Graphing options 440 allow the user to move ahead and back from the present time to see future and historical data, respectively, in graphical format.

It should be appreciated that the macroeconomic data and chart in FIGS. 4A and 4B allow a user to quickly specify and analyze the underlying conditions upon which various scenarios may be run.

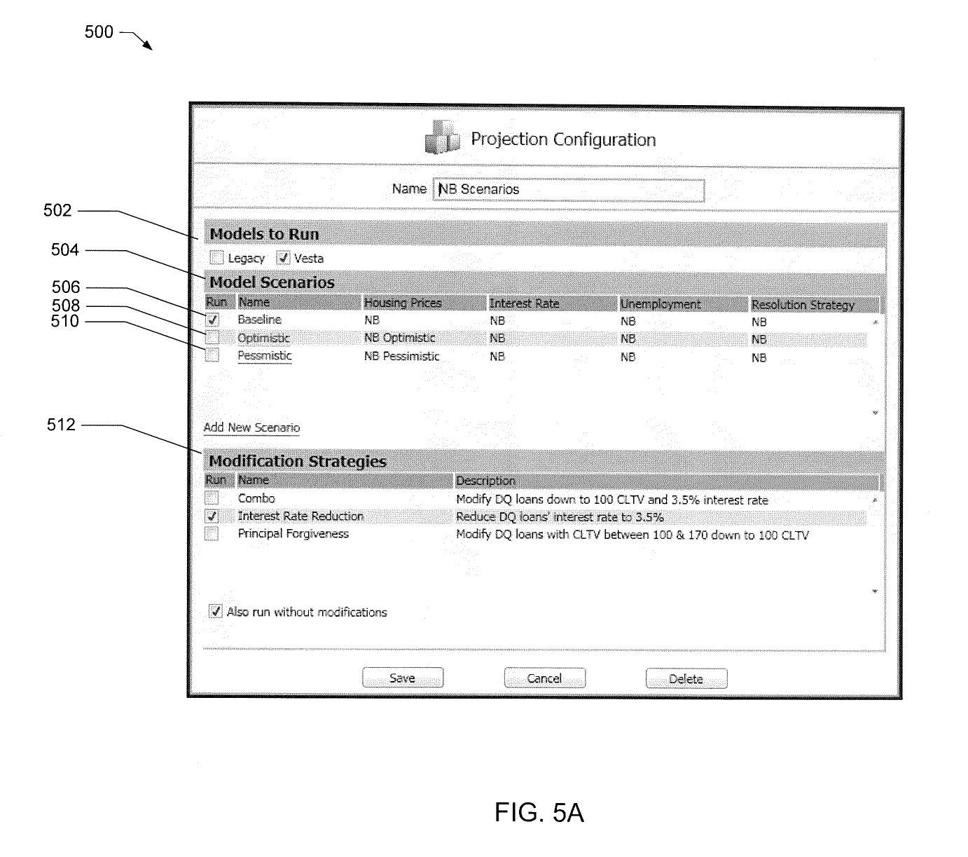

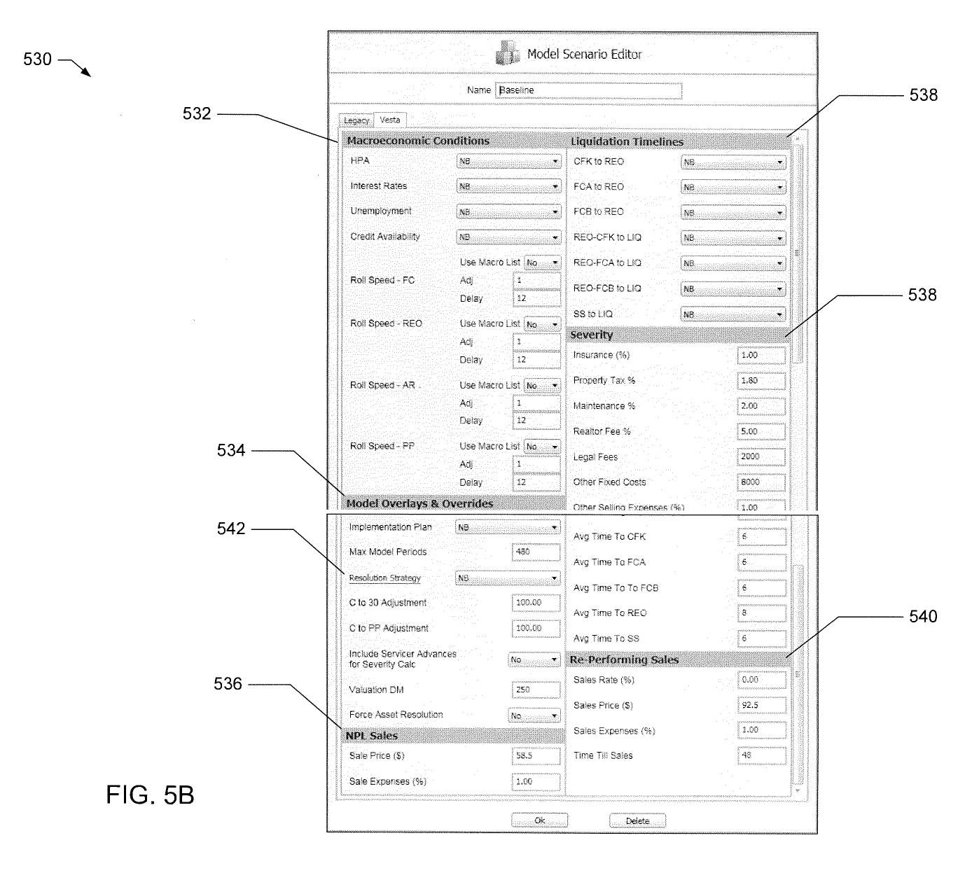

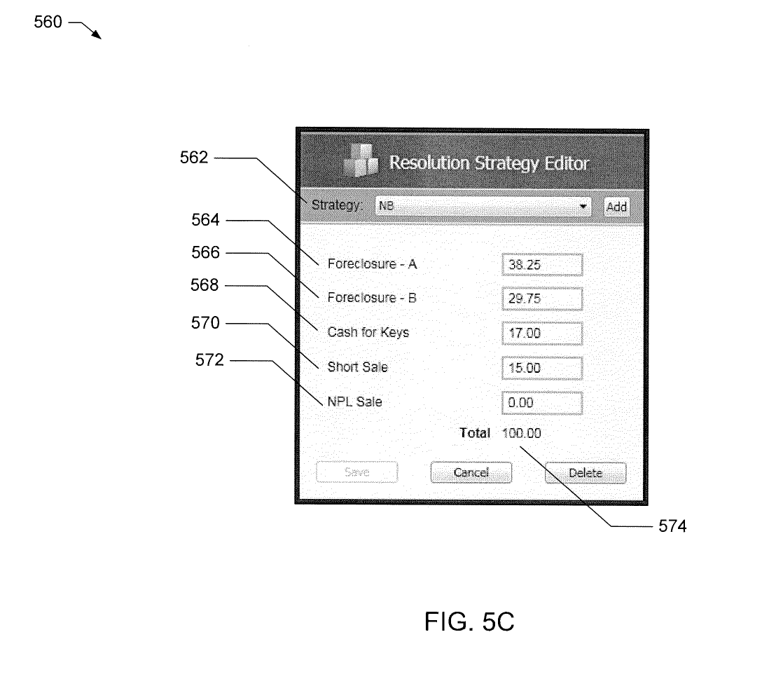

In one embodiment, when the user selects to create a new scenario 304, the user is then prompted to define the new scenario. Alternatively, the user may choose from existing scenarios. FIG. 5A illustrates an example screenshot 500 for defining or editing a projection scenario or configuration. A user can select models to run 502. A user can select model scenarios 504. For example, a user can specify a baseline scenario 506, an optimistic scenario 508, and a pessimistic scenario 510. It should be appreciated that with the example scenarios 506, 508 and 510, the user can run a scenario under the user's subject view of how the portfolio will perform. For example, the user can choose to run the baseline scenario, which may describe projections for the portfolio most likely to occur, or expected projections. If the user believes that the portfolio will outperform expectations, the user may choose to run an optimistic scenario 508. If the user believes that the portfolio will underperform compared to expectations, the user may choose to run a pessimistic scenario 510.

The user can also select models 502 to speed up or slow down certain timing aspects of the selected scenario or scenarios. For example, certain aspects of a projection may depend on aspects that are not loan-specific. For example, as described in further detail with model overlays and overrides 534 in FIG. 5B, a user can input adjustments that changes the overall speed of the scenario or how quickly a loan portfolio reaches resolution.

The user may also specify modification strategies 512. Modification strategies allow a user to modify certain aspects of an individual loan or a group of loans. For example, the user may change the terms of a loan by using modification strategies. For example, the user may modify delinquent loans down to 100 CLTV (combined loan to value) and 3.5% interest rate. Or the user may reduce delinquent loans' interest rate to 3.5%. Or, the user may choose to modify delinquent loans with CLTV between 100 and 170 down to 100 CTLV. Or, for example, a user may wish to change the terms of severity of a loan. For example, as described in further detail with severity 538 in FIG. 5B, a user can input adjustments that changes the severity of certain fees or taxes associated with an individual loan or a group of loans. Or, for example, a user may change the principal forgiveness, interest rate reduction or both.

Modification strategies allow the user to modify such values and rates so that the results for the portfolio may occur quicker or slower than without modification. The user can also view the results of the scenario and the results of the modification strategies simultaneously. It should be appreciated that viewing the results of the scenario and the results of the modification strategies simultaneously gives the user immediate and contextual feedback about the impact of the selected modification strategy. The user can thus easily see what effects a certain modification strategy would have on a scenario.

FIG. 5B illustrates an example screenshot 530 for defining or editing a model scenario. The user can define a scenario by specifying macroeconomic conditions 532, model overlays and overrides 534, NPL sales 536, liquidation timelines 538, severity of fees 538, and re-performing sales 540.

For example, the user can specify macroeconomic conditions such as HPA, interest rate, unemployment, etc., using the model scenario editor screen 530.

The user can also specify factors that affect the severity of fees, such as the number of months to increase lost interest before foreclosure, property tax rate as a percentage of the home value, maintenance costs as a percentage of the home value, realtor fee as a percentage of the home value, legal fees, and other fixed costs.

The user can also specify model information such as the implementation plan to use in a scenario. The user can also select relative stresses for a conditional repayment rate ramp, conditional foreclosure rate ramp, and short sale multipliers. In one embodiment, the user may be able to specify the relative stresses as either a single number specification or a flat specification.

A single number specification modifies the corresponding base-case curve by multiplying the base-case curve by a specified number. For example, if the user specifies 75 as the conditional repayment rate, the base-case forecasted conditional repayment rate curve will be multiplied by 0.75 and used in a scenario. A flat specification ignores the base-case curve and uses a flat forecast instead. For example, if the user specifies F10 as the conditional repayment rate, a flat constant conditional repayment rate of 10 will be used for the scenario regardless of the base-case model-forecasted conditional repayment rate curve.

The user can also specify information about the private mortgage insurance. For example, the user can specify the percentage of mortgage insurance expected to be paid by the insurer, or the number of months to delay a payment by the mortgage insurer.

A user may also specify resolution strategies 542. FIG. 5C illustrates an example screenshot 560 of a resolution strategy editor screen. The resolution strategy editor screen allows the user to specify the manner in which various scenarios may end or how loans may be resolved. The user can select a strategy 562 for how the loans will be resolved. In one embodiment, when a strategy 532 is selected, the resolution strategy editor displays five resolutions. A loan may resolve in foreclosure A 564, foreclosure B 566, cash for keys 568, short sale 570, or NPL sale 572. In one embodiment, the user can specify percentages of the loans that should be resolved in one of five manners. For example, a user may specify that 38.25% of loans resolve in foreclosure A, 29.75% of loans resolve in foreclosure B, 17% of loans resolve in cash for keys, 15% of loans resolve in short sales, and 0% of loans resolve in NPL sales, for a total of 100% 574. Thus, the user can allocate various manners in which different percentages of the loans will resolved. It should be appreciated that with the resolution strategy, the user can granularly control how the loans are resolved, give the user even more control over the scenarios.

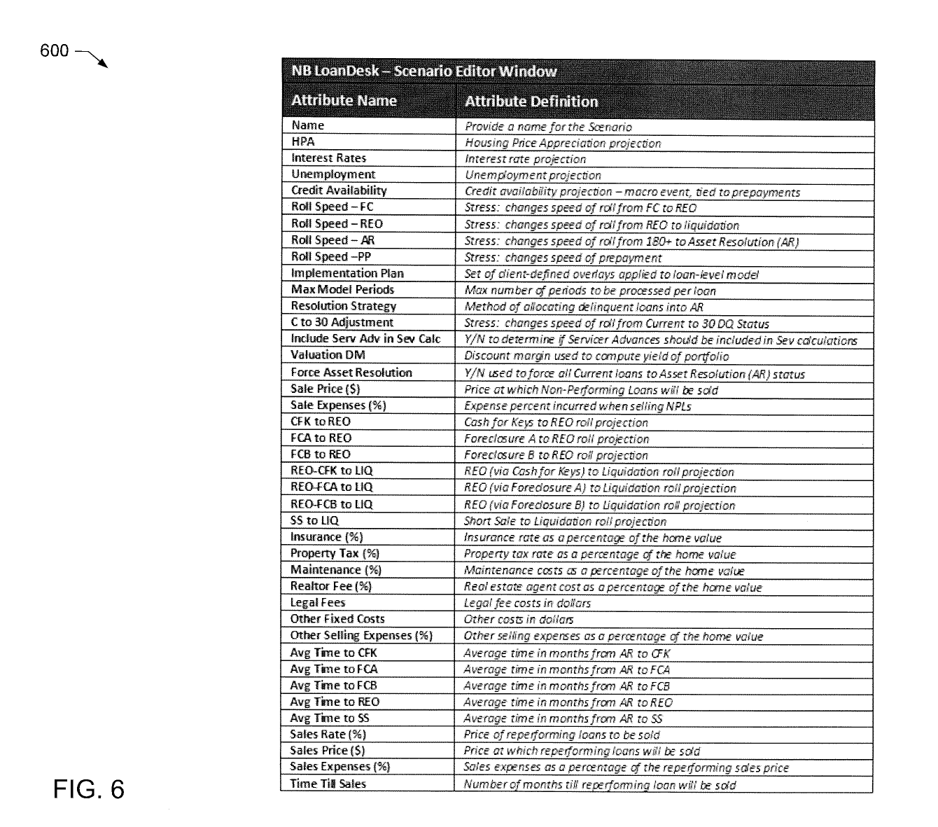

At any time, the user may view a description of each attribute that can be specified by the user. FIG. 6 illustrates an example screenshot 600 of different attributes and definitions that the user can specify in defining a scenario.

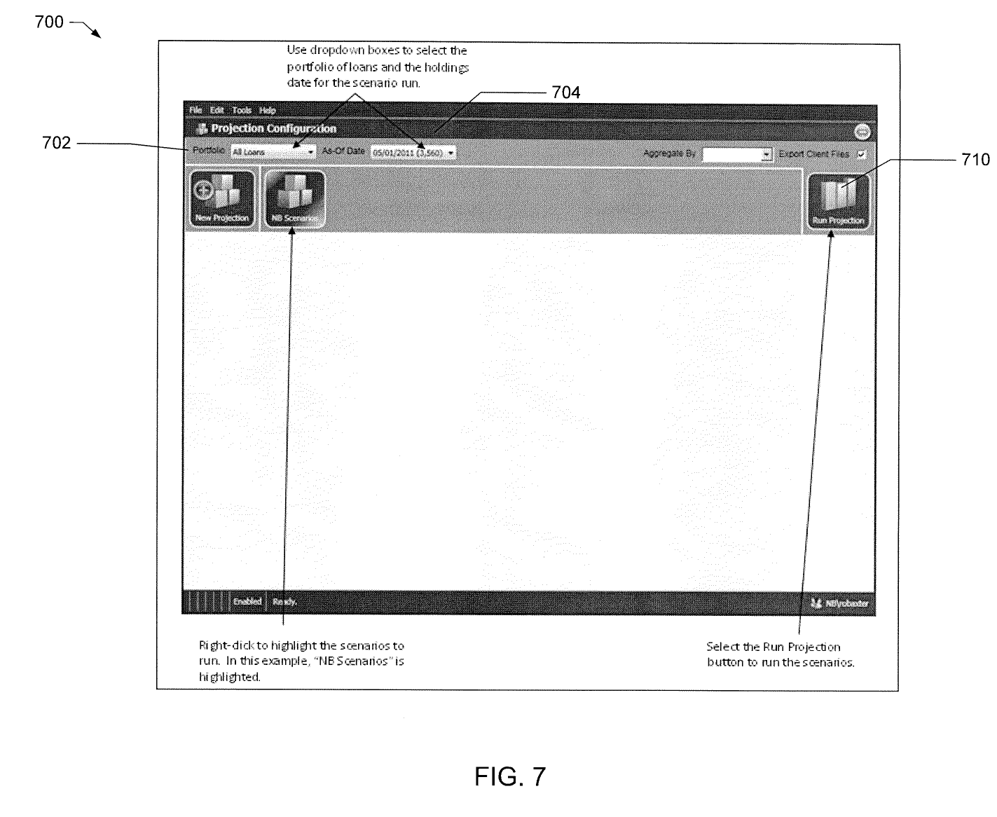

After defining the scenario, the user can also select the portfolio of loans and the holdings date for the scenario. FIG. 7 illustrates an example screenshot 700 for selecting a portfolio of loans 702 and the holdings date 704 for the scenario run. The user can select one or multiple scenarios to run. In the example of FIG. 7, the user highlights NB Scenarios, indicating he would like to run NB Scenarios under the specified conditions. After the user makes these selections, the user preferably saves the scenario and then runs it using button 710.

In one embodiment, the user specifies housing prices, interest rates, unemployment rates, a loan modification strategy, a resolution strategy, and model adjustments as part of a scenario.

In response to the user running a scenario, the mortgage loan portfolio valuation system generates results as interactive report tabs. In one embodiment, the mortgage loan portfolio valuation system analyzes the loan portfolio and the entered scenarios according to a model. In one embodiment, the model may be a set of statistical or analytical formulae that attempt to predict behavior of the entered loans.

The user can review the results at a variety of levels. For example, the user may review the results of the scenario run at the loan level. Or, the user may review the results of the scenario run at the aggregated level. For example, the user may view the results by an aggregation of a loan type, such as a fixed loan, a 7/1 ARM, a 5/1 ARM, or a second lien.

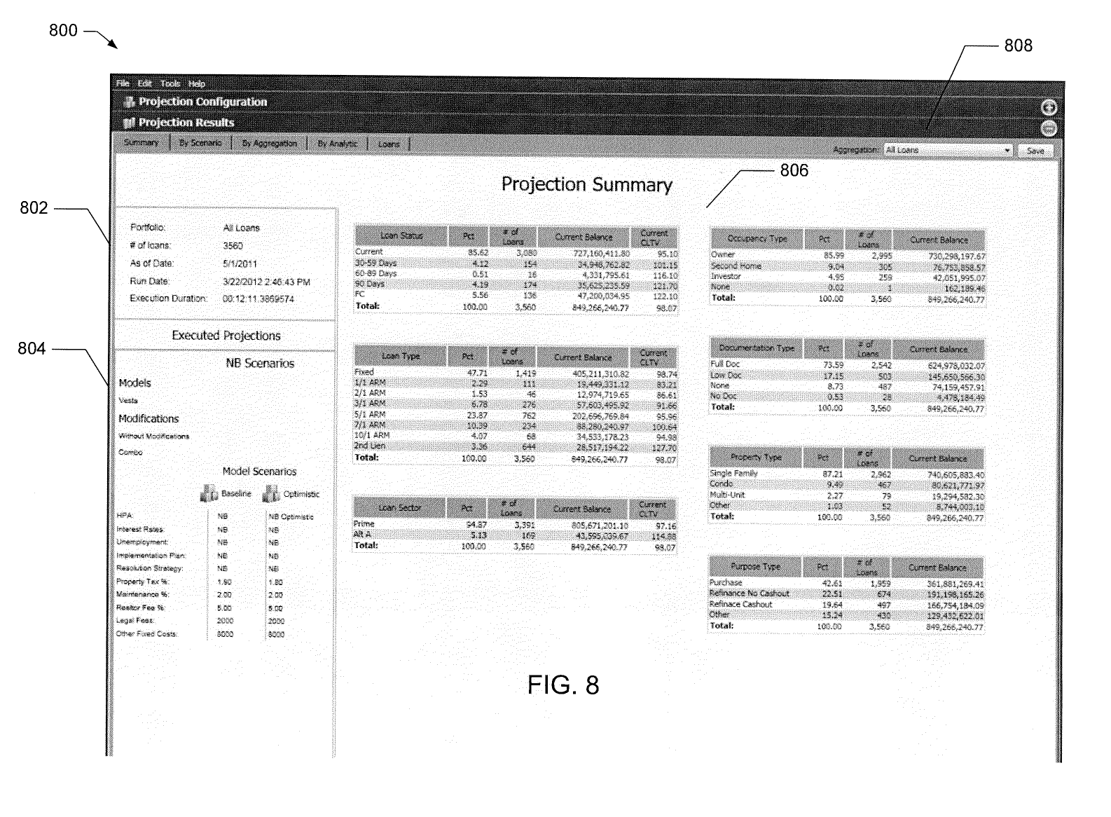

In one embodiment, the mortgage loan portfolio valuation system generates a Summary tab. FIG. 8 illustrates an example screenshot of a Summary tab 800. The Summary tab 800 displays details about the portfolio(s) that were run 802, the inputs used in each scenario 804, and a summary table 806 detailing the composition of the portfolio in the scenarios. In one embodiment, the summary table 806 displays the loan balances at the aggregated level specified by the user. The user can modify the aggregation level 808 directly from the Summary tab 800.

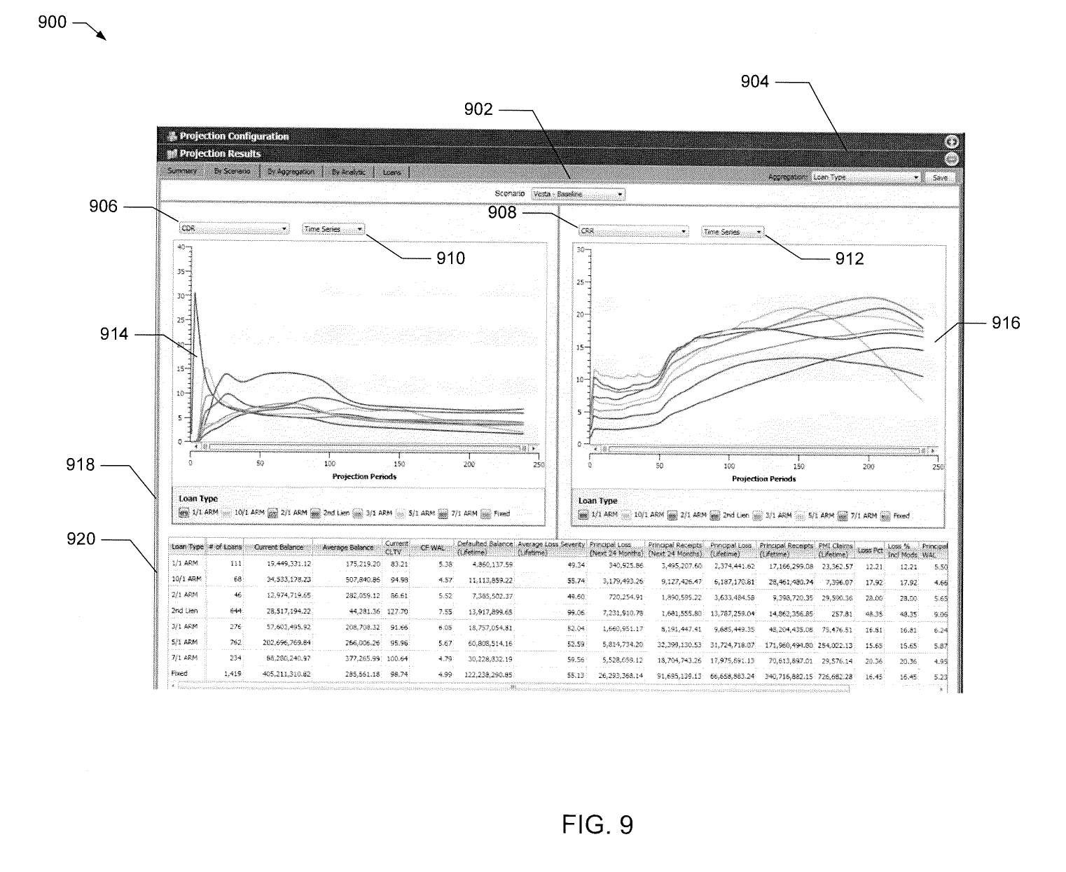

The mortgage loan portfolio valuation system may also generate a By Scenario tab, which displays graphs of ramps and summary scenario data for various scenarios and aggregation level chosen by the user. The user may use this tab to compare the results of different scenarios with each other. FIG. 9 illustrates an example screenshot of a By Scenario tab 900. In this example screenshot, the user can select the scenario for display 902, the aggregation level 904, and concepts or aspects 906 and 908 that the user can select to be graphed. It should be appreciated that the boxes in example screenshot 900 as well as any of the other screenshots with a downwards triangle indicates a drop-down box that can display other options that the user can select. For example, the user can use the drop-down box 902 associated with scenarios and select another scenario to view in the By Scenario tab.

In the example screenshot the user wishes to graph the constant default rate (CDR) and constant recovery rate (CRR) in time series. The user can specify that the graphs should be in time series 910 and 912. In one embodiment, the graphs may be presented in a cumulative manner instead of time series. The graphs 914 and 916 for the selected ramps are then displayed to the user. The graphs include projection results for various different loan types listed in legend 918. Section 920 allows the user to see details, on the same screen, for each of the loan types. The user can modify the aggregation level 904 directly from the By Scenario tab 900.

It should be appreciated that the By Scenario tab allows the user to compare all the various loan types, allows the user to select different ramps 906 and 908 to compare with each other in a graphical format, and see details for all the loan types being compared, all on one screen.

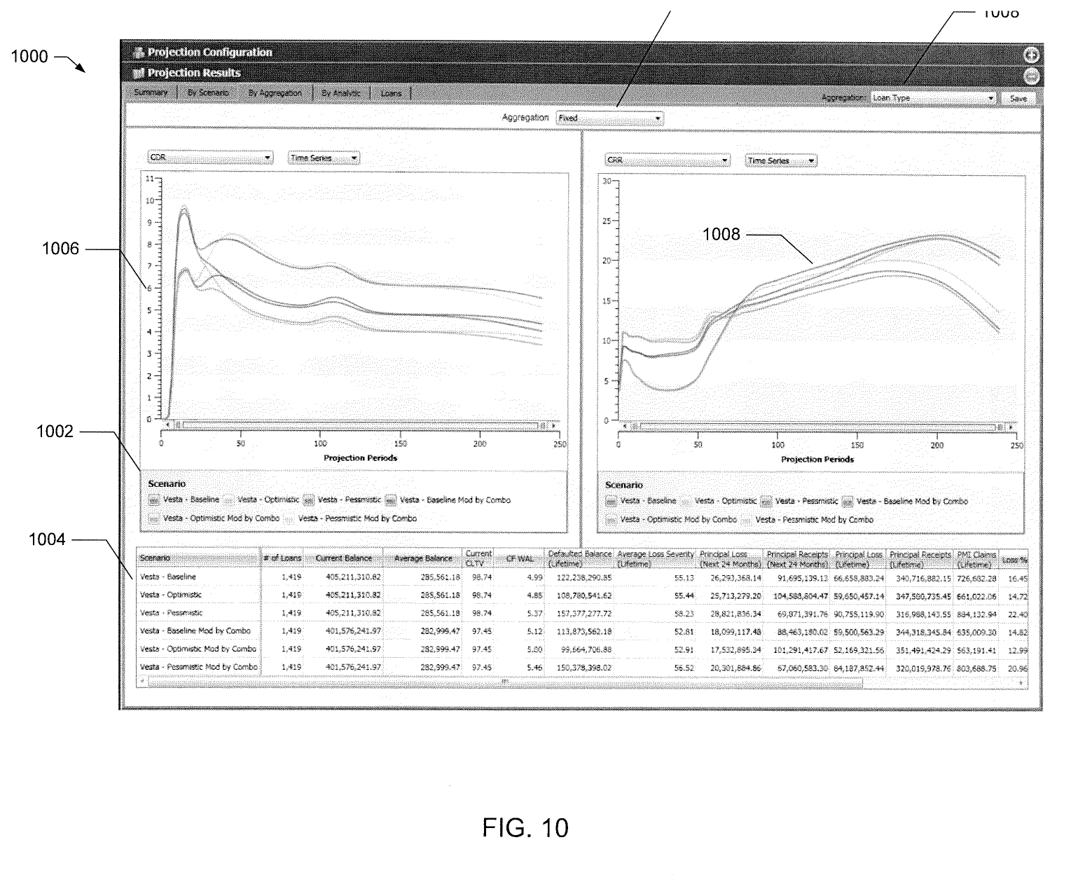

The mortgage loan portfolio valuation system may also generate a By Aggregation tab, which displays graphs of ramps by an aggregation level. The user may use this tab to compare the results of different aggregation levels with each other. FIG. 10 illustrates an example screenshot of a By Aggregation tab 1000. The user can again compare CDR data to CRR data in time series. The results are graphed 1006 and 1008. The graphs include projection results for various different scenarios listed in legend 1002. Section 1004 allows the user to see details, on the same screen, for each of the scenarios. The user can modify the aggregation information directly from the By Aggregation tab 1000 in two ways, using either dropdown box 1006 or 1008.

The mortgage loan portfolio valuation system may also generate a By Analytics tab, which displays plots of results under various analytical metrics.

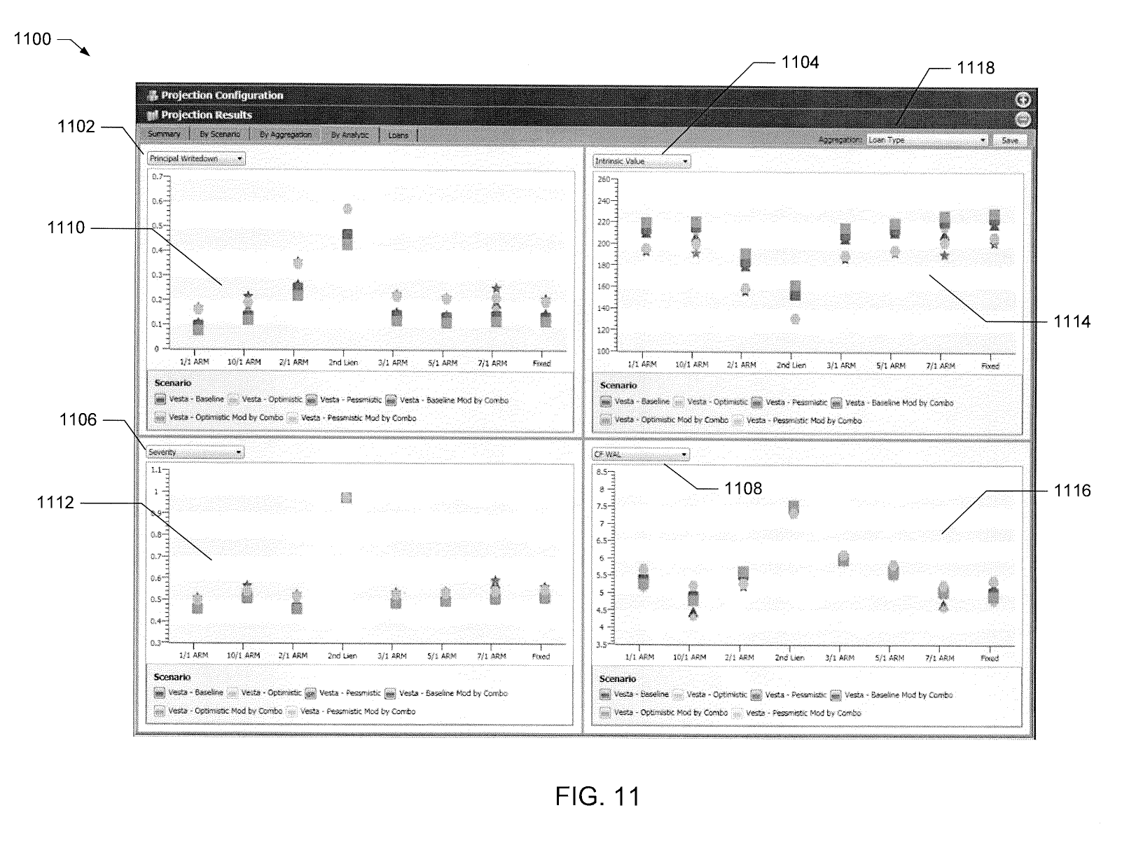

FIG. 11 illustrates an example screenshot of a By Analytics tab 1100. For example, the user may desire to compare the results of scenarios based on specific analytics such as principal writedown 1102, intrinsic value 1104, severity 1106, or conditional foreclosure 1108. The By Analytics tab 1100 presents these scenarios to the user as four graphs 1110, 1112, 1114, and 1116, respectively. The user can modify the aggregation level 1118 directly from the By Analytics tab 1100.

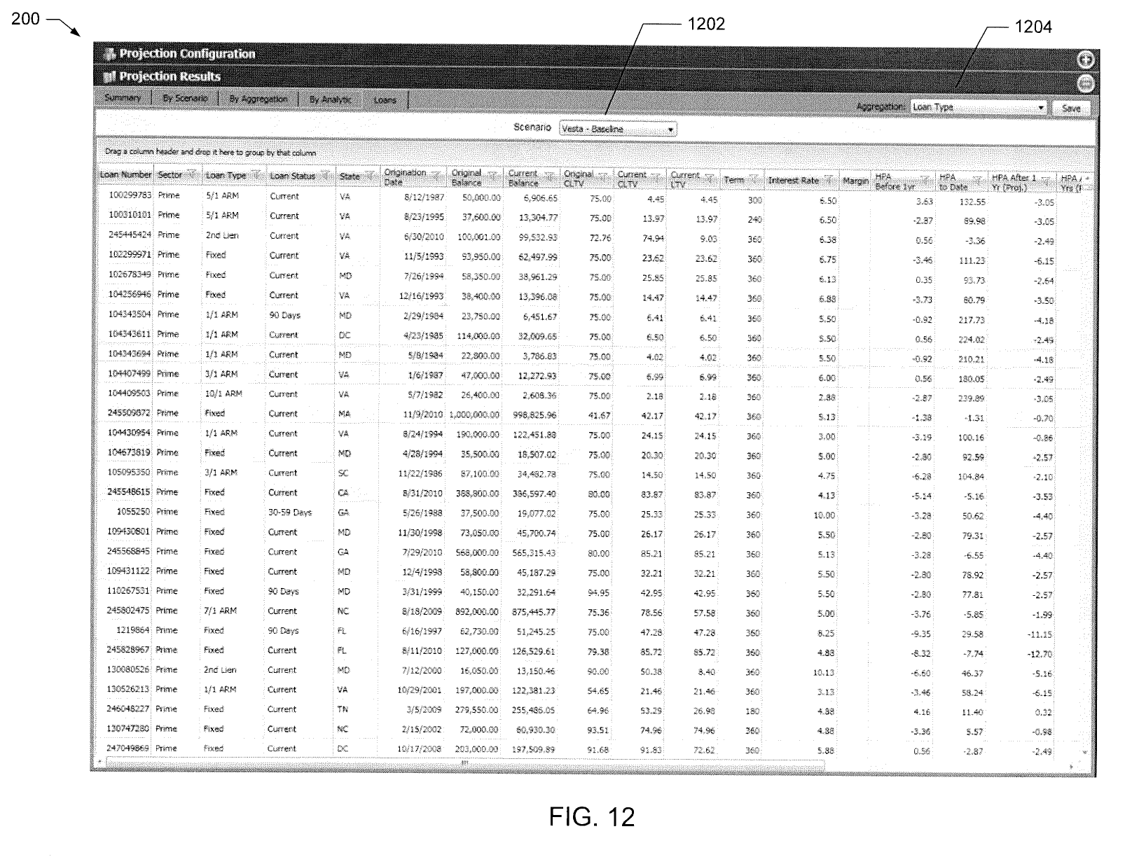

The mortgage loan portfolio valuation system may also generate a Loans tab, which displays information at the loan level for all of the loans included in the scenario run. FIG. 12 illustrates an example screenshot of a Loans tab 1200. The user can use dropdown box 1202 to select the scenario to project. The user can use dropdown box 1204 to select an aggregation level. In one embodiment, the information in the Loan tab is not aggregated, and there is no need for the user to specify an aggregation level. The user may click on any of the column headers to specify the sort order of the various loans.

It should be appreciated that, in one embodiment, the By Scenario, By Aggregation and By Analytics tabs allow the user to hold a certain aspect of the portfolio results constant and plot and compare other aspects of the results.

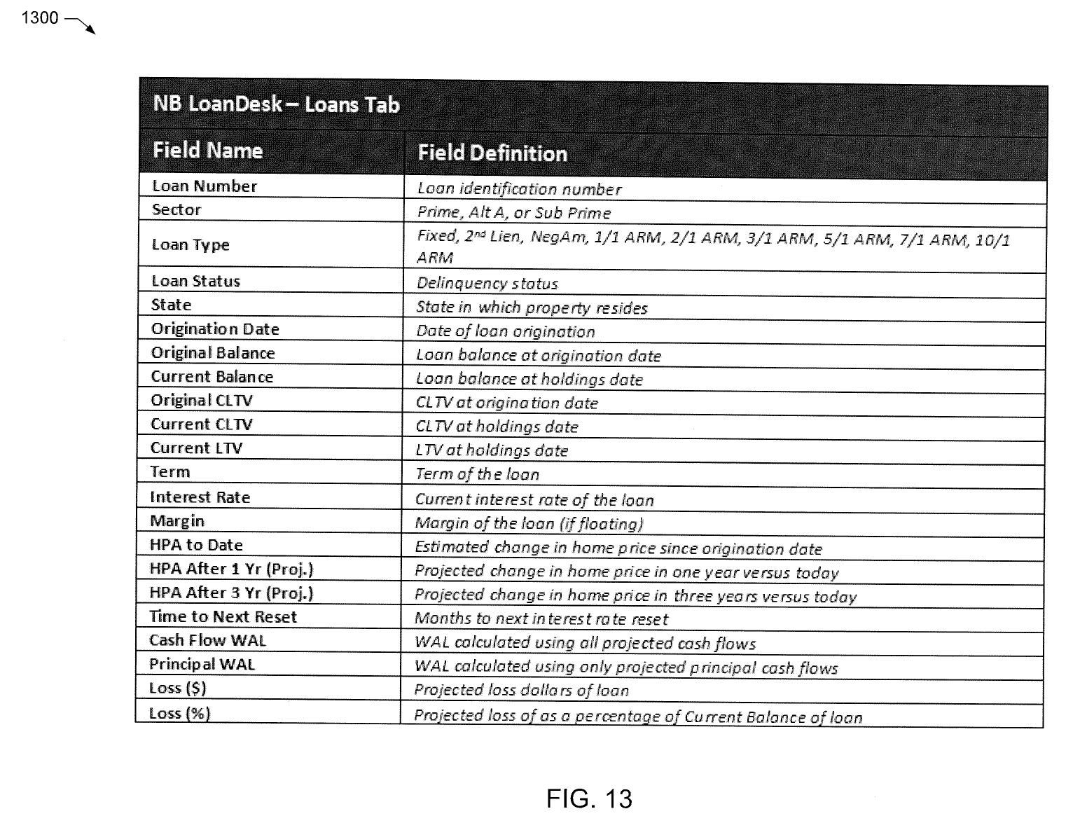

At any time, the user may view a description of each field name, shown as columns, in the Loans tab. FIG. 13 illustrates an example screenshot 1300 of different field names that the user can view for each loan included in the scenario run.

Some non-limiting example uses and applications of the mortgage loan portfolio valuation system will now be described. In one embodiment, a user may want to sell an individual loan and use the mortgage loan portfolio valuation system to evaluate the projected value of that individual loan. For example, the user may be able to analyze whether he should foreclose the loan. In one embodiment, a user may wish to sell only a certain percentage—e.g., 10—of an entire portfolio. The user can use the mortgage loan portfolio valuation system to analyze the feasibility and projected values of 10% of a portfolio. In one embodiment, a user may wish to predict the future value of a portfolio. The user may be a seller or a buyer of the portfolio. In one embodiment, a potential buyer interested in a portfolio of loans receives an electronic file that represents the portfolio of loans. The electronic file can be loaded into the mortgage loan portfolio valuation system and the portfolio of loans can then be analyzed.

In one embodiment, a user may use the mortgage loan portfolio valuation system to run a stress test or a projection rate on a portfolio of loans. The mortgage loan portfolio valuation system may be used for accounting or auditing purposes. For example, a user may wish to audit the value of a portfolio of loans for the next five years. The user can use the mortgage loan portfolio valuation system for the audit. In one embodiment, a user may wish to compare and contrast various modification strategies and use the mortgage loan portfolio valuation system for comparison and contrasting.

In summary, persons of ordinary skill in the art will readily appreciate that methods and apparatus for valuing mortgage loan portfolios have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims included in a corresponding utility patent application.

The invention is claimed as follows:

1. A method of valuing mortgage loan portfolios, the method comprising:
receiving a first scenario at a computing device, wherein the first scenario includes one of: (i) housing prices, (ii) interest rates, (iii) unemployment rates; (iv) a loan modification strategy; and (v) a resolution strategy;
receiving a portfolio of mortgage loans at the computing device, the portfolio of mortgage loans including a plurality of individual mortgage loan portfolios;
in response to receiving the first request and the portfolio of mortgage loans, calculating: (i) a projection of each individual mortgage loan portfolio under the first scenario, and (ii) a projection of the portfolio of mortgage loans under the first scenario; and
generating a plurality of interactive report tabs, wherein a first report tab displays the projection of the portfolio of mortgage loans under the first scenario and wherein a second report tab displays the projection of at least one individual mortgage loan portfolio under the first scenario.

2. The method of claim 1, further including modifying the first report tab to display the projection of at least one individual mortgage loan portfolio under the first scenario.

3. The method of claim 1, further including receiving a second scenario, and, in response to receiving the second scenario, calculating projections of the portfolio of mortgage loans under both the first scenario and the second scenario.

4. The method of claim 1, wherein the portfolio of mortgage loans includes information about residential real estate.

5. The method of claim 1, wherein the first scenario and the portfolio of mortgage loans are entered into a first model, and the report tabs include projections of behavior of the portfolio of mortgage loans based upon the first model.

6. The method of claim 5, wherein after generating the plurality of interactive report tabs, the first scenario and the portfolio of mortgage loans are entered into a second model.

7. The method of claim 1, wherein the resolution strategy contains a plurality of outcomes for the portfolio of mortgage loans, and wherein a user can assign percentages of the portfolio of mortgage loans to the plurality of outcomes.

8. The method of claim 1, wherein the loan modification strategy allows a user to modify the terms of a loan from the portfolio of mortgage loans.

9. The method of claim 1, wherein the plurality of interactive report tabs includes a By Scenario tab that holds the scenario constant and allows a user to modify aspects of the projection.

10. The method of claim 1, wherein the plurality of interactive report tabs includes a By Aggregation tab that holds an aggregation level of the portfolio of mortgage loans constant and allows a user to modify aspects of the projection.

11. The method of claim 1, wherein the plurality of interactive report tabs includes a By Analytics tab that allows a user to view the projection under a plurality of analytical metrics.

12. A method of valuing mortgage loan portfolios, the method comprising:
receiving a first request at a computing device to run a scenario associated with a residential mortgage loan portfolio;
determining first aggregate data associated with an outcome of the scenario based on subset data;
displaying the first aggregate data at the computing device;
receiving a second request at the computing device to display second aggregate data associated with the first aggregate data;
displaying the subset data in response to receiving the second request;
receiving a third request at the computing device to display an individual loan level detail associated with the subset data; and
displaying the individual loan level detail in response to receiving the third request.

13. The method of claim 12, wherein receiving the second request to display second aggregate data includes receiving a selection of the displayed first aggregate data at the computing device.

14. The method of claim 12, wherein receiving the third request to display individual loan level detail includes receiving a selection of the displayed subset data at the computing device.

15. A computing device for valuing mortgage loan portfolios, the computing device:
receiving a first scenario at a computing device, wherein the first scenario includes one of: (i) housing prices, (ii) interest rates, (iii) unemployment rates; (iv) a loan modification strategy; and (v) a resolution strategy;
receiving a portfolio of mortgage loans at the computing device, the portfolio of mortgage loans including a plurality of individual mortgage loan portfolios;
in response to receiving the first request and the portfolio of mortgage loans, calculating: (i) a projection of each individual mortgage loan portfolio under the first scenario, and (ii) a projection of the portfolio of mortgage loans under the first scenario; and
generating a plurality of interactive report tabs, wherein a first report tab displays the projection of the portfolio of mortgage loans under the first scenario and wherein a second report tab displays the projection of at least one individual mortgage loan portfolio under the first scenario.

16. A non-transitory computer readable medium storing software instructions for valuing mortgage loan portfolios which, when executed, cause an information processing apparatus to:
receive a first scenario at a computing device, wherein the first scenario includes one of: (i) housing prices, (ii) interest rates, (iii) unemployment rates; (iv) a loan modification strategy; and (v) a resolution strategy;
receive a portfolio of mortgage loans at the computing device, the portfolio of mortgage loans including a plurality of individual mortgage loan portfolios;
in response to receiving the first request and the portfolio of mortgage loans, calculate: (i) a projection of each individual mortgage loan portfolio under the first scenario, and (ii) a projection of the portfolio of mortgage loans under the first scenario; and
generate a plurality of interactive report tabs, wherein a first report tab displays the projection of the portfolio of mortgage loans under the first scenario and wherein a second report tab displays the projection of at least one individual mortgage loan portfolio under the first scenario.
